(19) United States
(12) Patent Application Publication
(10) Pub. No.: US 2011/0246086 A1
(43) Pub. Date: Oct. 6, 2011

(54) OPTICAL RESISTANCE COUPLED APPARATUS AND METHOD

(75) Inventors: Weijie Huang, Monrovia, CA (US); James Andrew Loussaert, Los Angeles, CA (US); Timothy E.r Burch, San Gabriel, CA (US)

(73) Assignee: SMITHS DETECTION INC., Edgewood, MD (US)

(21) Appl. No.: 13/133,633

(22) PCT Filed: Dec. 9, 2009
(86) PCT No.: PCT/US2009/067285

§ 371 Date: Jun. 8, 2011

Related U.S. Application Data
(60) Provisional application No. 61/193,610, filed on Dec. 10, 2008.

(51) Int. Cl. G06F 19/00; G01J 1/00; G01N 7/00

(52) U.S. Cl. 702/22; 356/213; 73/23.2

(57) ABSTRACT

A method and apparatus for detecting a particular chemical in a sample, includes placing the sample in contact with a semiconductive material provided on a flow cell. An electrical characteristic of the semiconductive material is detected by an interdigitated electrode, and a first signal indicative thereof of output. An optical characteristic of the semiconductive material is detected by a photodetector and a second signal indicative thereof is output. Based on the first and second signals, it is determined by a processor as to whether or not the particular chemical is present in the sample.

### CROSS-REFERENCE TO RELATED PATENT APPLICATIONS

This application claims priority of U.S. Provisional Application No. 61/193,610, filed Dec. 10, 2008, which is hereby incorporated by reference.

### FIELD

The field is semiconductor sensors, including carbon nanotube sensors, intrinsic conducting polymer (ICP) sensors and the like.

### BACKGROUND

Sensor devices having sensor arrays are becoming very useful in today's society, with the threat of chemi and bio-terrorism being more and more prominent. In more detail, chemical and biological warfare pose both physical and psychological threats to military and civilian forces, as well as to civilian populations.

An important feature of a sensor array unit is the ability to detect abnormalities in a sample, and to output an alarm when the abnormality is detected. Given that an abnormality may occur when only a very small concentration of a particular analyte exists in a sample, it is important that the sensor array unit is highly sensitive to such a very small concentration of the particular analyte.

Semiconducting materials such as carbon nanotube sensors exhibit good properties for detecting trace amounts of certain chemicals. It is desirable to utilize carbon nanotube sensors for detecting many types of chemicals, and to develop metrics for assuring proper detection of those chemicals.

### SUMMARY

Accordingly, there is a need for a method and apparatus for detecting chemicals using semiconductor sensor materials.

In accordance with one aspect, there is provided an apparatus for detecting a particular chemical. The apparatus includes a flow cell having an optically transparent window provided thereon. The apparatus also includes a light source disposed on the first side of the flow cell outside of the flow cell. The apparatus further includes a semiconductive material disposed within the flow cell where the optically transparent window is located. The apparatus still further includes at least one interdigitated electrode disposed within the flow cell where the optically transparent window is located, the electrode being in contact with the semiconductive material. The apparatus also includes a photodetector provided a second side of the flow cell opposite the first side of the flow cell, the photodetector being disposed outside of the flow cell. The apparatus further includes a processor that is electrically connected to the electrode and the photodetector and which receives first and second signals respectively output from the electrode and the photodetector with respect to a particular band. The processor determines whether or not the particular chemical is included in a sample incident on the apparatus.

In accordance with another aspect, there is provided a method for detecting a particular chemical in a sample. The method includes placing the sample in contact with a semiconductive material provided on a flow cell. An electrical characteristic of the semiconductive material is detected by at least one interdigitated electrode, and a first signal indicative thereof of output. An optical characteristic of the semiconductive material film is detected by a photodetector, and outputting a second signal indicative thereof is output. Based on the first and second signals, it is determined by a processor as to whether or not the particular chemical is present in the sample.

In accordance with yet another aspect, there is provided a computer readable medium embodying computer program product for detecting the presence or absence of a particular chemical in a sample. The computer program product, when executed by a computer or a microprocessor, causes the computer or the microprocessor to perform a step of placing the sample in contact with a semiconductive material provided on a flow cell. An electrical characteristic of the semiconductive material is detected by at least one interdigitated electrode, and a first signal indicative thereof of output. An optical characteristic of the semiconductive material is detected by a photodetector, and outputting a second signal indicative thereof is output. Based on the first and second signals, it is determined by a processor as to whether or not the particular chemical is present in the sample.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments and, together with the description, serve to explain the principles of the invention.

FIG. 1 is a plot showing changes in electrical characteristics of a poly aminobenzene sulfonic acid functionalized single walled carbon nanotubes (PABS-SWNT) film and changes in optical adsorption characteristic of the PABS-SWNT film over an S₁₁ band, when exposed to hydrogen cyanide (HCN), according to a first embodiment.

FIG. 2 is a plot showing changes in electrical characteristics of a PABS-SWNT film and changes in optical adsorption characteristic of the PABS-SWNT film over an S₁₁ band, when exposed to hydrogen chloride (HCl), according to the first embodiment.

FIG. 3 is a plot showing changes in electrical characteristics of a PABS-SWNT film and changes in optical adsorption characteristic of the PABS-SWNT film over an S₁₁ band, when exposed to chlorine (Cl₂), according to the first embodiment.

FIG. 4 is a plot showing changes in electrical characteristics of a PABS-SWNT film and changes in optical adsorption characteristic of the PABS-SWNT film over an S₁₁ band, when exposed to ammonia (NH₃), according to the first embodiment.

FIG. 5 is a plot showing the increased observed intensity of the S₁₁ band and the spectral features of the PABS-SWNT material as it is exposed to 30 ppm NH₃, according to the first embodiment.

FIG. 6 is a plot showing changes in electrical characteristics of an octadecylamine functionalized single wall carbon nanotubes (ODA-SWNT) film and changes in optical adsorption characteristic of the ODA-SWNT film over an S₁₁ band, when exposed to hydrogen cyanide (HCN), according to the first embodiment.

FIG. 7 is a plot showing changes in electrical characteristics of an ODA-SWNT film and changes in optical adsorption characteristic of the ODA-SWNT film over an S₁₁ band, when exposed to hydrogen chloride (HCl), according to the first embodiment.

FIG. 8 is a plot showing changes in electrical characteristics of an ODA-SWNT film and changes in optical adsorption characteristic of the ODA-SWNT film over an S₁₁ band, when exposed to chlorine (Cl₂), according to the first embodiment.

FIG. 9 is a plot showing changes in electrical characteristics of an ODA-SWNT film and changes in optical adsorption characteristic of the ODA-SWNT film over an S₁₁ band, when exposed to ammonia (NH₃), according to the first embodiment.

FIG. 10 is a block diagram of a sensor device according to a first embodiment.

FIG. 11 is a view along an x-z axis of the sensor device according to the first embodiment.

FIG. 12 is a view along an x-y axis of the sensor device according to the first embodiment.

FIGS. 13a-13c respectively represent the density of states of semiconducting SWNTs, doped SWNTs, and metallic SWNTs, and FIG. 13d is a schematic illustration of the S₁₁ and S₂₂ electronic spectrum of SWNTs.

### DETAILED DESCRIPTION

Reference will now be made in detail to embodiments, examples of which are illustrated in the accompanying drawings. An effort has been made to use the same reference numbers throughout the drawings to refer to the same or like parts.

Unless explicitly stated otherwise, “and” can mean “or,” and “or” can mean “and.” For example, if a feature is described as having A, B, or C, the feature can have A, B, and C, or any combination of A, B. and C. Similarly, if a feature is described as having A, B, and C, the feature can have only one or two of A, B, or C.

Unless explicitly stated otherwise, “a” and “an” can mean “one or more than one.” For example, if a device is described as having a feature X, the device may have one or more of feature X.

The inventors of this application have found that functionalized carbon nanotubes. In one embodiment, the nanotubes can be single-walled nanotubes. In another embodiment, the nanotubes can be poly aminobenzene sulfonic acid (PABS) functionalized. In a further embodiment, the nanotubes can be poly aminobenzene sulfonic acid functionalized single-walled nanotubes (PABS-SWNT). PABS-SWNTs display unique optical-electrical signatures when exposed to chemical vapors. Accordingly, it can be useful to measure the optical properties and electrical properties (conductance or resistance) of PABS-SWNT. In one embodiment, both the near infrared (NIR) absorption of the S₁₁ band and the electrical conductance (or resistance) of the PABS-SWNT material can be measured. In one embodiment, the measurement of NIR absorption of the S₁₁ band and the electrical conductance (or resistance) can be measured on the same sample, can be measured successively, and can be measured simultaneously.

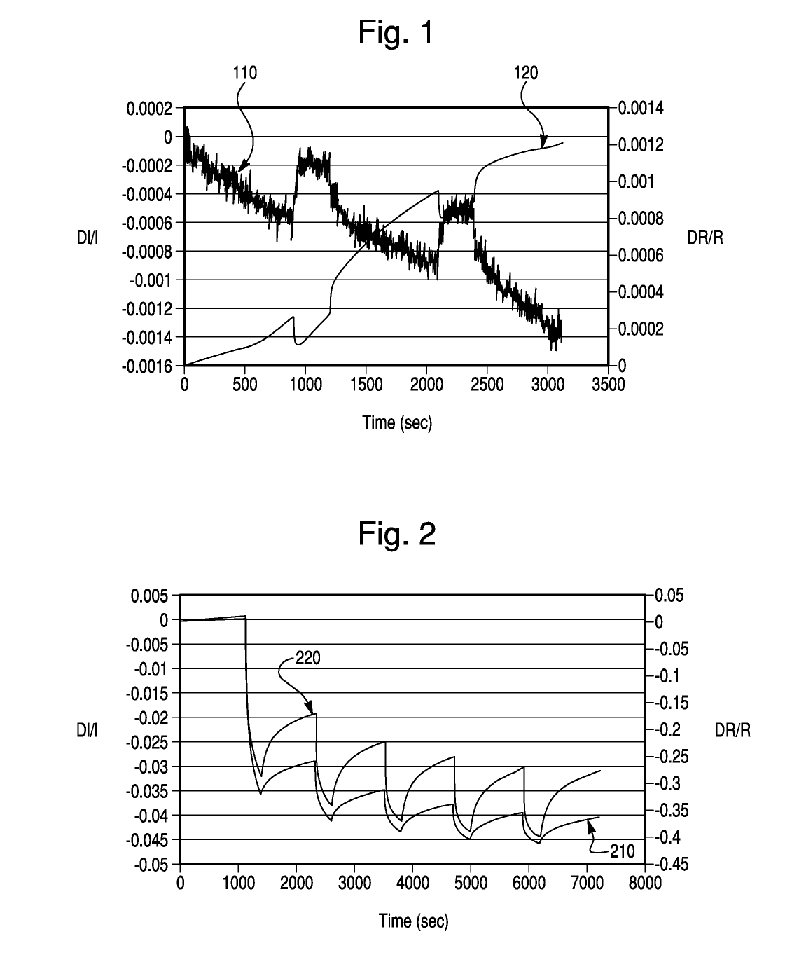

Any suitable chemical compound can be detected. In one embodiment, the chemical vapor can be hydrogen cyanide (HCN). Without being tied to any given theory, the inventors of this application have found that when PABS-SWNT material is exposed to HCN, the observed optical absorption of the S₁₁ band increases and the conductance of the material increases in direct proportion; i.e., the optical adsorption and the resistance of the materials change in opposite directions, as illustrated in FIG. 1 (50 ppm HCN in-situ response). The optical adsorption data is shown by plot 110, and the resistance data is shown by plot 120. The S₁₁ band for a nanotube can depend on the diameter of the nanotube, and is typically a band within a range from approximately 100 nm to approximately 1500 nm. For example, a nanotube having a diameter of 1.01 nm can have an S₁₁ band at 1190 nm. The type of carbon nanotubes used in one embodiment is composed of nanotubes with a distribution of diameters which show typical S₁₁ band between approximately 1420 nm to approximately 2500 nm.

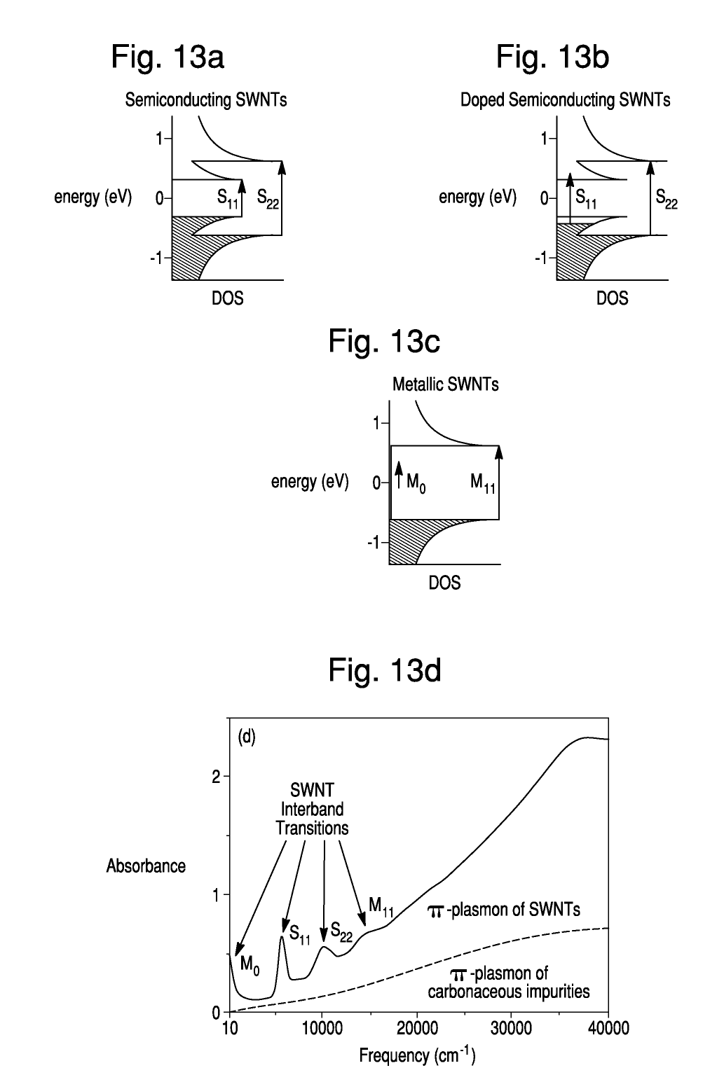

The nature of electronic structure of SWNTs around the Fermi level can be associated with the interband transitions of interests. FIGS. 13a-13d represent the density of states of semiconducting SWNTs and metallic SWNTs. For semiconducting SWNTs produced by chemical vapor deposition method, S₁₁ and S₂₂ refer to the first and second interband transitions which occur near approximately 4000 to approximately 7000 cm⁻¹ (or 1428 nm-2500 nm) and approximately 7750 to approximately 11750 cm⁻¹ (850 nm-1290 nm) respectively. The S₁₁ band can be more susceptible to doping effect. Without being tied to a particular theory, the wide band width likely is due to the mixing SWNTs of different diameter and bundle sizes. In more detail, FIG. 13a shows a schematic representation of the density of states (DOS) of semiconducting SWNTs in which S₁₁ and S₂₂ correspond to the first and second interband transitions which occur in the near-IR spectral range, FIG. 13b shows a schematic representation of the density of states (DOS) of hole doped semiconducting SWNTs in which the first interband transition (S₁₁ doped) is reduced in intensity due to depletion of the conduction band, and FIG. 13c shows a schematic representation of the density of states (DOS) of metallic SWNTs. FIG. 13d is a schematic illustration of the electronic spectrum (absorbance versus frequency) of SWNTs. FIGS. 13a-13d are reproduced from M. E. Itkis, S. Niyogi, M. E. Meng, M. A. Hamon, H. Hu, R. C. Haddon, “Spectroscopic Study of the Fermi level Electronic Structure of single-Walled Carbon Nanotubes”, Nano Lett. 2002, 2 pgs, 155-159, and M. E. Itkis, D. E. Perea, R. Jung, S. N iyogi, R. C. Haddon, “Comparison of Analytical Techniques for Purity Evaluation of Single-Walled Carbon Nanortubes”, J. Am Chem. Soc. 2005, 127, pgs. 3439-3448.

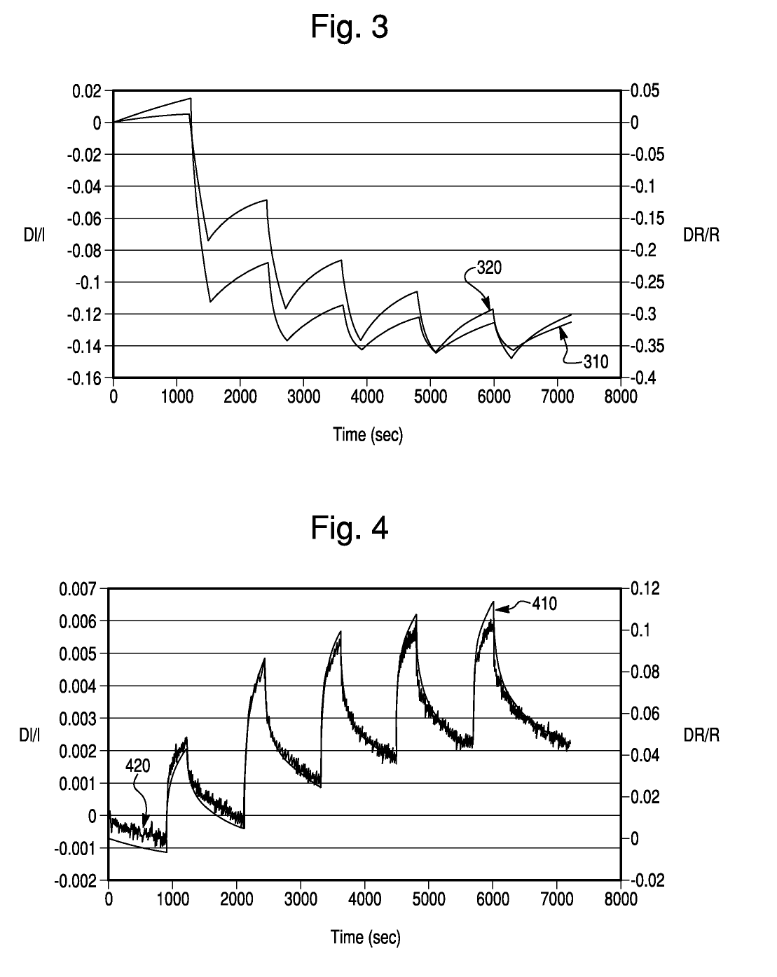

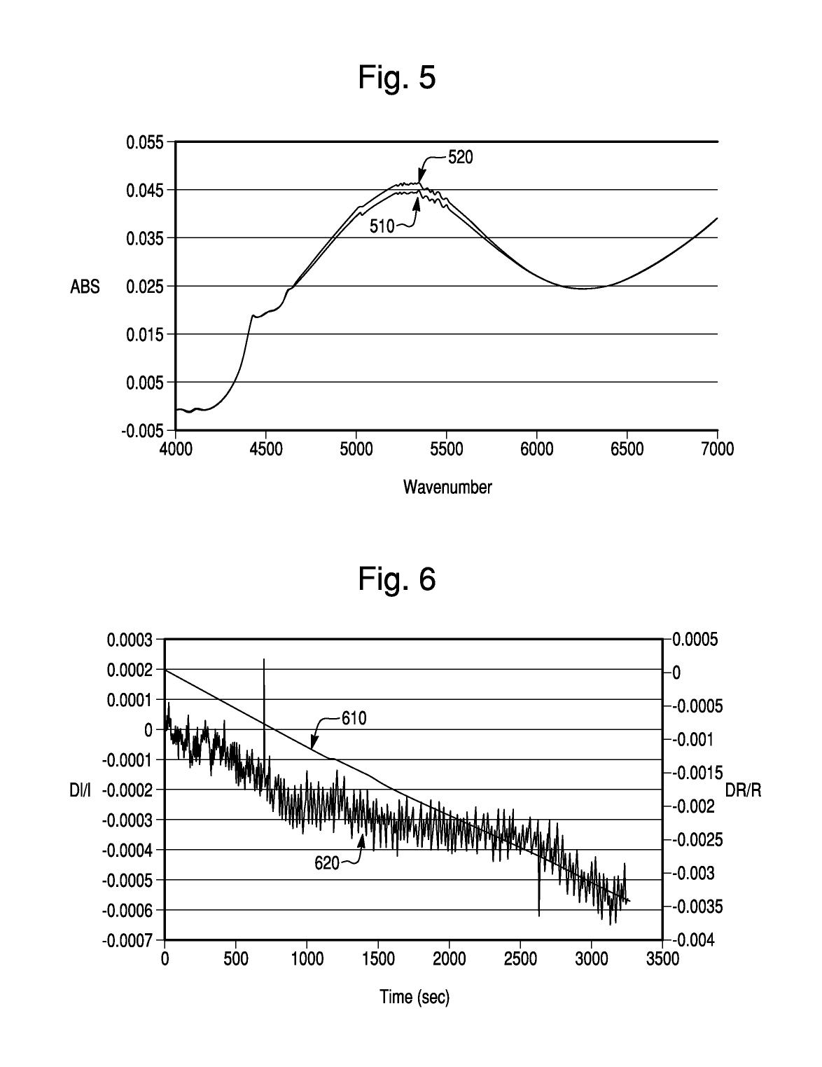

PABS-SWNT material can differentiate between HCN vapor and other chemicals, such as, for example, HCl, Cl₂, and NH₃ (ammonia) as shown in FIGS. 2, 3 and 4. In more detail, FIG. 2 shows an electrical resistance plot 210 and an optical absorption plot 220 with respect to the responses of a PABS-SWNT material to 50 ppm HCl, FIG. 3 shows an electrical resistance plot 310 and an optical absorption plot 320 with respect to the responses of a PABS-SWNT material to 10 ppm Cl₂, and FIG. 4 shows an electrical resistance plot 410 and an optical absorption plot 420 with respect to the responses of a PABS-SWNT material to 300 ppm NH₃. FIG. 5 shows the increased observed intensity of the S₁₁ band and the spectral features of the PABS-SWNT material as it is exposed to 30 ppm NH₃, whereby plot 520 shows the effects of exposure to NH₃ and plot 510 shows the “before exposure to NH₃” characteristics. The detection characteristics also can vary depending upon the functionalization of a carbon nanotube material. For example, HCN response can differ between PABS-SWNT and another carbon nanotube material, such as, for example, octadecylamine functionalized single wall carbon nanotubes (ODA-SWNT).

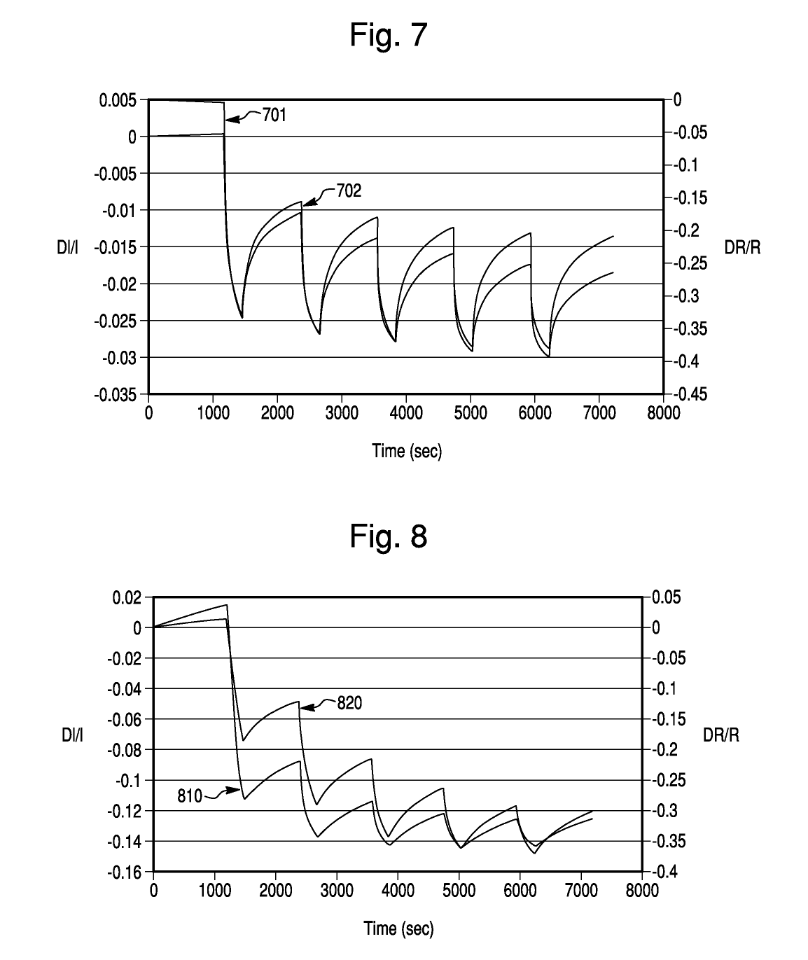

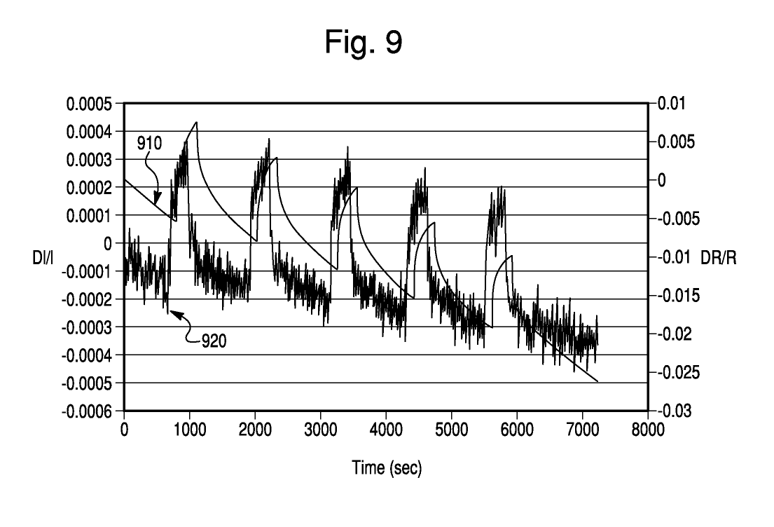

For ODA-SWNT and other chemical vapor analytes, experiments performed by the inventors of this application have determined that the optical absorbance and electrical resistance change in direct relation with each other. FIGS. 6, 7, 8 and 9 show the observed optical intensity versus resistance characteristics of the ODA-SWNT material as it is exposed to HCN, HCl, Cl₂, and NH₃, respectively. In more detail, FIG. 6 shows an electrical resistance plot 610 and an optical absorption plot 620 with respect to the responses of an ODA-SWNT material to 50 ppm HCN, FIG. 7 shows an electrical resistance plot 701 and an optical absorption plot 702 with respect to the responses of an ODA-SWNT material to 50 ppm HCl, FIG. 8 shows an electrical resistance plot 810 and an optical absorption plot 820 with respect to the responses of an ODA-SWNT material to 10 ppm Cl₂, and FIG. 9 shows an electrical resistance plot 910 and an optical absorption plot 920 with respect to the responses of an ODA-SWNT material to 300 ppm NH₃.

Without being tied to a particular theory, the mechanism for the HCN “increase versus decrease” characteristics could be attributed to charge transfer competition between HCN, the functional group (PABS), and the modified SWNT band structure other than acid-base modulated SWNT band gap changes. See, for example, E. Bekyarova et al., “Mechanism of Ammonia Detection by Chemically Functionalized Single-Walled Carbon Nanotubes: in-situ Electrical and Optical Study of Gas Analyte Detection”, published in J. Am. Chem. Soc., 2007, vol. 129, pgs. 10700-10706.

A sensor device can measure both the optical absorption and the electrical resistance changes, i.e., the optical-electrical signature as a metric. Any suitable analyte or combination of analytes can be examined using a coupled optical-resistance change in a functionalized carbon nanotube, such as, for example, a PABS-SWNT material. In addition to applications for chemical vapor detection, this phenomenon could be used as an actuator to trigger or control other devices or events, e.g., in chemical synthesis or chemical processing using gas. In one embodiment, the chemical synthesis or processing can be of HCN gas.

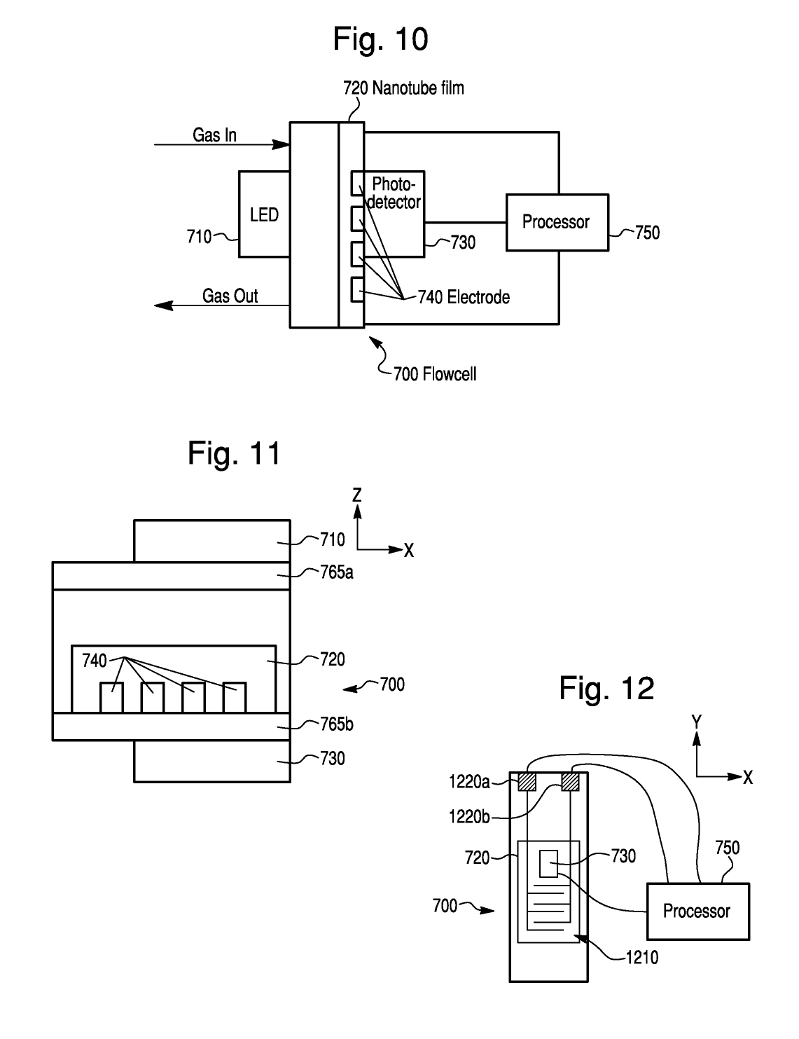

A block diagram of a sensor device according to a first embodiment is shown in FIG. 10. The flow cell 700 can have optically transparent windows at appropriate wavelength for the nanotube S₁₁ absorption affixed with a mid-IR lasing LED light source 710 directly to a window on one side of the flowcell 700 and a photodetector 730 affixed directly to the window on the opposite side of the flowcell 700. A sensing material, which corresponds to a nanotube film 720 (SWNT) in the first embodiment, can be deposited on the window on the opposite side of the flowcell 700, with the photodetector 730 being disposed under an interdigitated electrode 740, whereby the electrode 740 can measure the resistance of the nanotube film 720 and whereby the photodetector 730 can measure the optical adsorption characteristics of the nanotube film 720. The photodetector 720 and the electrode 740 can be electrically connected to a microprocessor 750, which respectively can receive a first and a second signals from these two elements, and which can interpret the first and second signals. Additional elements can be measured and, accordingly, additional signals can be received and interpreted.

FIG. 11 is a view along an x-z axis of the sensor device according to the first embodiment, whereby the electrical leads to the microprocessor 750 are not shown for ease in explanation of that figure (but see FIG. 10). An interdigitated electrode 740 is provided within an optically transparent window of the flow cell 700, and the nanotube film (or layer) 720 is deposited on the electrode 740. The electrode 740 and the nanotube film 720 can be sealed into the flowcell 700 within a top optically transparent glass plate 765a and a bottom optically transparent glass plate 765b that form the optically transparent window (with the electrode 740 and the nanotube film 720 sealed therebetween). The optically transparent window with the electrode 740 and nanotube film 720 provided therein is referred to as the bottom of the flowcell 700, and the optically transparent window with no electrode 740 is referred to as the top of the flowcell 700. On the outsides of the flowcell 720 are provided the LED 710 and the photodetector 730. The LED 710 is affixed the top of the flowcell 720 and the photodetector 730 is affixed to the bottom of the electrode 740. The electrode 740 can be chemically resistant, so that it will not break down over time as gases are input to and output from the flow cell 700 for detection of those gases.

Both the top and the bottom of the flow cell 720 can be made with any optically transparent material, such as, for example, glass, plastic or crystal (the top optically transparent plate 765a and the bottom optically transparent plate 765b), so that the casing of the flow cell 700 will not interfere with light passing through the sensing material 720 (e.g., the nanotube film in the first embodiment). The top window of the flow cell 700 can be made of any optically transparent material, such as, for example, glass, plastic or crystal, for example. The bottom of the flow cell 700 can include an optically transparent plate (e.g., glass, plastic or crystal), the interdigitated electrode 740, electrical leads (capable of connecting the electrode 740 to the processor 750, and the sensing material 720 (e.g., the nanotube film).

The optical window is the area of the flow cell 700 that light can pass through, unhindered by electrodes or electrical leads. This is where the optical sensing can take place, whereby this area of the flow cell 700 also can have the sensing material 720 deposited therein. In this embodiment, light can pass freely from a light source 710 (e.g., LED, incandescent bulb, fluorescent tube, etc.) affixed to the outside of the top of the flow cell 720 through the top plate 765a of the optically transparent window, then through free space, then through the sensing material 720, and then through the bottom plate 765b of the optically transparent window of the flowcell 720. The light then is incident on the photodetector 730 affixed to the outside of the bottom of the flowcell 720. FIG. 12 shows the electrode 740 provided only on the bottom of the flow cell 700, whereby the x-z axis view of the flow cell 700 as shown in FIG. 11 is of the bottom of the flow cell 700, and whereby the x-z axis view of the top of the flow cell 700 is similar to FIG. 11 except that there are no electrodes 740 present in that region of the flow cell 700. The light source 710 is not shown in FIG. 12, whereby it is located on the other side of the flowcell 700 and is blocked from view by the photodetector 730 (but see FIG. 10).

By way of example and not by way of limitation, the microprocessor 750 can execute a program stored in a computer readable medium (e.g., a computer disk). The microprocessor 750 can access data stored in a memory (not shown), whereby the memory stores conductance and optical adsorption data corresponding to previous tests performed on known samples, whereby when there is a sufficient match between the stored memory data and the data corresponding to the first and second signals (e.g., their respective values are at least within at least approximately 85, at least approximately 90, or at least approximately 95% of each other over at least approximately 85, at least approximately 90, or at least approximately 95% of the S₁₁ band), then the microprocessor 750 can determine that there is a match, and that the particular chemical corresponding to the stored memory data is determined to exist in a sample incident on the flow cell 700 (and whereby the microprocessor 750 outputs an indication, such as an alarm, or visual display, to denote such a match to a user). In more detail, the microprocessor 750 processes and interprets the optical and conductance signals received from the photodetector 730 and the electrode 740, and makes a decision as to whether or not to issue an alarm and whether or not to perform further agent classification/identification.

The wide range of carbon nanotube bandgaps (from 0.4 to 6 eV) that are currently available makes carbon nanotubes very suitable for fabrication of sensors in the electromagnetic radiation band, e.g., from UV to IR. It also allows for building wide sensitive range radiation detectors. A wide variety of semiconductive materials could be used for a thin-film sensor according to the present invention, or placed adjacent to the sensor to make an array of sensors and provide additional discrimination of chemical vapors.

One possible implementation of a mid-IR lasing LED light source 710 as shown in FIG. 10 and FIG. 11 would be a parabolic reflector, whereby such a parabolic reflector could minimize the number of optics required as the light source 710 would stay focused over a relatively short optical path length across the flowcell 700 and would be collected by the photodetector 730. Any suitable parabolic reflector can be used, such as, for example, one manufactured by Dora Texas Corporation in Houston, Tex. The electrode 740 can be disposed such that it would not obstruct the light path. The electrical and optical signals can be collected from the same nanotube film 720 or can be collected from two separate nanotube films provided on the flow cell 700. In one embodiment, the optical and electrical signals are collected by the same nanotube film 710. The “two nanotube films” implementation can be used for, among other things, detecting particular chemicals in a sample at low concentration levels.

Using a combination of using both optical and electrical signals to detect a particular chemical using a SWNT film in a flow cell can enable better selectivity for a range of chemicals in array based chemical sensors.

An exemplary method of manufacturing a flow cell 700 in accordance with the first embodiment is described below. The flow cell 700 can be made starting from a glass slide, with gold deposited on the entire surface of the glass slide. Then, a gold design pattern 1210 can be made on the glass slide, as seen in FIG. 12, to thereby form a pattern that can be used to create an interdigitated electrode 740. Next, a sensor material (e.g., SWNT) can be deposited on the interdigitated electrode 740 and an open area between two leads 1220a and 1220b (that connect to the processor 750) as a window for a light path through the flow cell 700. The window for the light path is what is referred to above as the “optical window.” The bottom of the flow cell 700 can be covered with the interdigitated electrode 740 and an SWNT (sensor material) 720, whereby the SWNT 720 can act as a resistor that changes its conductivity as the chemical nature or chemical environment changes (e.g., a chemiresistor). The flow cell 700 can then placed into a chamber, whereby spacers can be placed on all four sides of the electrode 740 in the z direction. Then, using adhesives, a clear, clean, glass ceiling can be sealed above the electrode 740, leads, optical window, and SWNT 720, whereby a space is left in the sides of the flow cell 700 for inlets and outlets for gas flow.

The embodiments described above have been set forth herein for the purpose of illustration. This description, however, should not be deemed to be a limitation on the scope. Various modifications, adaptations, and alternatives may occur to one skilled in the art without departing from the claimed inventive concept. For example, while there has been demonstrated unique properties of ODA-SWNT and PABS-SWNT nanotube materials for detecting HCl, Cl₂, HCN and NH₃, other types of semiconductive materials could be used for a thin-film sensor, or placed adjacent to a thin-film sensor, to thereby make an array of sensors and provide additional discrimination of chemical vapors. By way of example, chemiresistive sensing materials such as Intrinsically Conductive Polymers (ICP) or metal decorated SWNT (MD-SWNT) can be utilized for the thin-film sensor provided on the flow cell. Also, other features within the full SWNT spectrum from IR to UV may hold relevant signatures that can be used to detect certain chemicals and gases using a nanotube material provided within a flow cell. The spirit and scope of the invention are indicated, but not limited, by the following claims.

What is claimed is:

1. An apparatus for detecting a particular chemical in a sample incident on the apparatus, comprising:
a flow cell having an optically transparent window provided thereon;
a light source disposed on the first side of the flow cell outside of the flow cell;
a semiconductive material disposed within the flow cell where the optically transparent window is located;
at least one electrode disposed within the flow cell where the optically transparent window is located, the electrode being in contact with the semiconductive material;
a photodetector provided a second side of the flow cell opposite the first side of the flow cell, the photodetector being disposed outside of the flow cell;
a processor that is electrically connected to the photodetector and the electrode and which receives first and second signals respectively output from the photodetector and the electrode,
wherein the processor determines whether or not the particular chemical is included in a sample incident on the apparatus.

2. The apparatus according to claim 1, wherein the first signal provides an indication of an optical absorption of the semiconductive material and wherein the second signal provides an indication of a conductance of the semiconductive material.

3. The apparatus according to claim 1, wherein the semiconductive material is a pristine or functionalized carbon nanotube film.

4. The apparatus according to claim 1, wherein the semiconductive material is an intrinsically conductive polymer (ICP).

5. The apparatus according to claim 1, wherein the semiconductive material is an inorganic semiconductor.

6. The apparatus according to claim 1, wherein the light source is an LED.

7. The apparatus according to claim 1, wherein the electrode is an interdigitated electrode.

8. The apparatus according to claim 1, further comprising
a memory configured to store data corresponding to conductance and optical characteristics for at least one chemical with respect to a particular band of interest,
wherein the processor accesses the data stored in the memory and compares it with the first and second signals respectively output from the photodetector and the electrode with respect to the particular band of interest, and determines whether or not there is a match to thereby indicate presence of the at least one chemical in a sample incident on the flow cell.

9. The apparatus according to claim 1, wherein the sample is a gas sample.

10. The apparatus according to claim 3, wherein the carbon nanotube film is a poly aminobenzene sulfonic acid functionalized single walled carbon nanotube.

11. The apparatus according to claim 3, wherein the carbon nanotube film is an octadecylamine functionalized single wall carbon nanotube.

12. A method of detecting a particular chemical in a sample, comprising:
placing the sample in contact with a semiconductive material provided on a flow cell;
detecting an electrical characteristic of the semiconductive material, and outputting a first signal indicative thereof;
detecting an optical characteristic of the semiconductive material, and outputting a second signal indicative thereof; and
based on the first and second signals, determining whether or not the particular chemical is present in the sample.

13. The method according to claim 12, wherein the semiconductive material is a pristine or functionalized carbon nanotube film.

14. The method according to claim 12, wherein the semiconductive material is an intrinsically conductive polymer (ICP).

15. The method according to claim 12, wherein the semiconductive material is an inorganic semiconductor.

16. The method according to claim 13, wherein the carbon nanotube film is a poly aminobenzene sulfonic acid functionalized single walled carbon nanotube.

17. The method according to claim 13, wherein the detecting an optical characteristic step is performed by a photodetector provided on one surface of the flow cell outside of the flow cell.

18. The method according to claim 13, wherein the detecting an electrical characteristic step is performed by at least one interdigitated electrode provided within the flow cell.

19. A method according to claim 13, wherein the determining step is performed by comparing data obtained from the first and second signals with data stored in a memory, and determining whether or not they substantially match.

20. The method according to claim 13, wherein the sample is a gas sample.

21. A computer readable medium embodying computer program product for detecting a particular chemical in a sample, the computer program product, when executed by a computer or a microprocessor, causing the computer or the microprocessor to perform the steps of:
placing the sample in contact with a semiconductive material provided on a flow cell;
detecting an electrical characteristic of the semiconductive material, and outputting a first signal indicative thereof;
detecting an optical characteristic of the semiconductive material, and outputting a second signal indicative thereof; and
based on the first and second signals, determining whether or not the particular chemical is present in the sample.

22. The computer readable medium according to claim 21, wherein the semiconductive material is a pristine or functionalized carbon nanotube film.

23. The computer readable medium according to claim 21, wherein the semiconductive material is an intrinsically conductive polymer (ICP).

24. The computer readable medium according to claim 21, wherein the semiconductive material is an inorganic semiconductor.

25. The computer readable medium according to claim 22, wherein the carbon nanotube film is a poly aminobenzene sulfonic acid functionalized single walled carbon nanotube.

26. The computer readable medium according to claim 21, wherein the detecting an optical characteristic step is performed by a photodetector provided on one surface of the flow cell outside of the flow cell.

27. The computer readable medium according to claim 21, wherein the detecting an electrical characteristic step is performed by at least one interdigitated electrode provided within the flow cell.

28. A computer readable medium according to claim 21, wherein the determining step is performed by comparing data obtained from the first and second signals with data stored in a memory, and determining whether or not they substantially match.

29. The computer readable medium according to claim 21, wherein the sample is a gas sample.
